(19) United States
(12) Patent Application Publication
(10) Pub. No.: US 2025/0039751 A1
(43) Pub. Date: Jan. 30, 2025

(54) DE-CONFIGURATION OF MOBILITY MANAGEMENT

(71) Applicant: Nokia Solutions and Networks Oy, Espoo (FI)

(72) Inventors: Guillaume Decarreau, Munich (DE); Benoist Pierre Sebire, Tokyo (JP); Chunli Wu, Beijing (CN)

(21) Appl. No.: 18/713,140

(22) PCT Filed: Nov. 29, 2021
(86) PCT No.: PCT/CN2021/134036

§ 371 Date: May 23, 2024

(51) Int. Cl. H04W 36/00

(52) U.S. Cl. CPC H04W 36/00837; H04W 36/0061; H04W 36/0085

(57) ABSTRACT

Example embodiments of the present disclosure relate to devices, methods, apparatuses and computer readable storage media for de-configuration of mobility management. In example embodiments, a first network device transmits, to a second network device, an instruction of de-configuration of mobility management for a terminal device. Moreover, the first network device obtains, from the second network device, an identification of a serving cell for the terminal device.

### FIELD

Example embodiments of the present disclosure generally relate to the field of communications, and in particular, to devices, methods, apparatuses and computer readable storage media for de-configuration of mobility management.

### BACKGROUND

With development of communications technologies, there is a new network architecture proposed to split functions of a base station in an access network for improving flexibility of deployment. Some functions of the base station are deployed on a centralized unit (CU), and other functions are deployed on a distributed unit (DU). For example, The CU may be responsible for some high level protocol stack functions and the DU may be responsible for the lower level functions.

Mobility management is very important to enable mobility services in the fifth generation New Radio (5G NR). Currently, under the above new network architecture, some mobility management mechanisms have been developed. For example, a mechanism of management of layer 1 (L1) mobility has been proposed recently. It is required that the DU is responsible for the management of the mobility of user equipment (UE) between the cells within its coverage based on the L1 measurements from the UE, without any further mobility-related instruction from the CU. However, in some scenarios where the position of the UE is not changing or changing in a slow manner, unnecessary frequent L1 measurements and reporting will lead to large resource overhead.

### SUMMARY

In general, example embodiments of the present disclosure provide devices, methods, apparatuses and computer readable storage media for de-configuration of mobility management.

In a first aspect, a method is provided. In the method, a first network device transmits, to a second network device, an instruction of de-configuration of mobility management for a terminal device. Moreover, the first network device obtains, from the second network device, an identification of a serving cell for the terminal device.

In a second aspect, a method is provided. In the method, a second network device receives, from a first network device, an instruction of de-configuration of mobility management for a terminal device. Moreover, the second network device transmits, to the first network device, an identification of a serving cell for the terminal device.

In a third aspect, a first network device is provided which comprises at least one processor and at least one memory including computer program code. The at least one memory and the computer program code are configured to, with the at least one processor, cause the first network device to transmit, to a second network device, an instruction of de-configuration of mobility management for a terminal device. Moreover, the first network device is caused to obtain, from the second network device, an identification of a serving cell for the terminal device.

In a fourth aspect, a second network device is provided which comprises at least one processor and at least one memory including computer program code. The at least one memory and the computer program code are configured to, with the at least one processor, cause the second network device to receive, from a first network device, an instruction of de-configuration of mobility management for a terminal device. Moreover, the second network device is caused to transmit, to the first network device, an identification of a serving cell for the terminal device.

In a fifth aspect, there is provided an apparatus comprising means for performing the method according to the first or second aspect.

In a sixth aspect, there is provided a computer readable storage medium comprising program instructions stored thereon. The instructions, when executed by a processor of a device, cause the device to perform the method according to the first or second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the first network device and the second network device according to some example embodiments of the present disclosure;

FIG. 3 illustrates an example process according to some example embodiments of the present disclosure;

FIG. 4 illustrates a flowchart of an example method according to some example embodiments of the present disclosure;

FIG. 5 illustrates a flowchart of an example method according to some other example embodiments of the present disclosure; and

FIG. 6 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station or a device that can implement some of functions of the base station, such as a CU or a DU. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In the third generation partnership project (3GPP) Release 17 (Rel-17), layer 1 (L1) centric mobility just began to be discussed. There are some discussions about Liaison Statement (LS) on Transmission Configuration Indicator (TCI) state update for L1/layer 2 (L2)-Centric inter-cell mobility. Some further enhancements on MIMO for NR have been proposed. Further, there are also some discussions about L1/L2 mobility in Release 18 (Rel-18) workshop. It is discussed that L1/L2 mobility was one of the most proposed mobility enhancement area and L1/L2-centric inter-cell mobility proposals also under MIMO topic.

As discussed above, there is an existing scheme for mobility management of the UE. In this existing scheme, UE performs cell change between a set of configured cells controlled by a DU. The UE provides L1 measurements for a serving cell and neighbor cells to the DU. Accordingly, the DU triggers a change of the terminal device from the serving cell to a neighbor cell, for example, in the same way as a change from a current beam to a target beam. In general, the CU would not be informed about the cell change.

However, in some scenarios, for example, where the position of the UE is not changing or changing in a slow manner, unnecessary frequent L1 measurements and reporting will lead to large resource overhead. But, by now, there is no effective and efficient approach to enable the CU to take back control of the mobility management of the UE.

Example embodiments of the present disclosure provide a scheme of de-configuration of mobility management. With the scheme, a network device (referred to as a first network device), such as a CU, transmits an instruction of de-configuration of mobility management for a terminal device to another network device (referred to as a second network device), such as a DU. Moreover, the first network device obtains an identification of a serving cell for the terminal device from the second network device. Then, in some example embodiments, according to the obtained identification, the first network device may trigger a change of the terminal device from the serving cell to the neighbor cell based on measurements for the serving cell and a neighbor cell from the terminal device.

This scheme reduces signaling overhead and power consumption by requiring much less frequent layer 3 (L3) measurements for the serving cell and a neighbor cell and L3 event reports. As such, cell handover may be performed more efficiently.

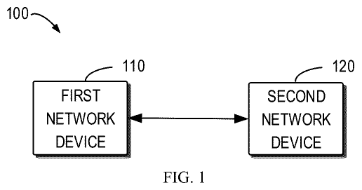

FIG. 1 shows an example environment 100 in which example embodiments of the present disclosure can be implemented.

The environment 100, which may be a part of a communication network, comprises two network devices 110 and 120 communicating with each other or with other devices via each other. For the purpose of discussion, the devices 110 and 120 will be referred to as a first network device 110 and a second network device 120, respectively.

The first and second network devices 110 and 120 may be implemented by any suitable devices in the communication network. In some example embodiments, the first network device 110 may be implemented by a CU and the second network device 120 may be implemented by a DU, or vice versa. Just for the purpose of discussion, in some example embodiments, the CU will be taken as an example of the first network device 110, and the DU will be taken as an example of the second network device 120.

It is to be understood that two devices are shown in the environment 200 only for the purpose of illustration, without suggesting any limitation to the scope of the present disclosure. In some example embodiments, the environment 200 may comprise a further device to communicate synchronization assistance information with the first network device 110 and the second network device 120. As an example, the third device may comprise a terminal device.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

According to some example embodiments of the present disclosure, the first network device 110 transmits an instruction of de-configuration of mobility management for a terminal device to the network device 120. Moreover, the second network device transmits an identification of a serving cell for the terminal device to the first network device. Then, in some example embodiments, according to the obtained identification, the first network device may trigger a change of the terminal device from the serving cell to the neighbor cell based on measurements for the serving cell and a neighbor cell from the terminal device.

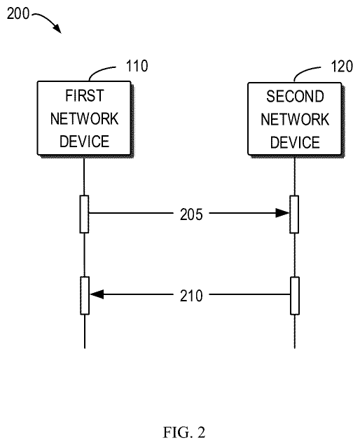

FIG. 2 shows a signaling flow 200 between the first network device 110 and the second network device 120 according to some example embodiments of the present disclosure. For the purpose of discussion, the signaling flow 200 will be described with reference to FIG. 1.

As shown in FIG. 2, the first network device 110 transmits (205) an instruction of de-configuration of mobility management for a terminal device to the second network device 120. In some example embodiments, the first network device 110 may transmit the instruction of de-configuration of mobility management for the terminal device to the second network device 120, if the first network device 110 receives a request for the de-configuration of the mobility management for the terminal device from the second network device 120. For example, the second network device 120 may transmit the request for the de-configuration of the mobility management for the terminal device to the first network device 110, if the second network device 120 determines that a distance of movement of the terminal device is within a determined threshold distance. As another example, the second network device 120 may transmit the request for the de-configuration of the mobility management for the terminal device to the first network device 110, if a load of the second network device is higher than a threshold load. As a further example, the second network device 120 may transmit the request for the de-configuration of the mobility management for the terminal device to the first network device 110, if the UE move out of the coverage of the second network device 120.

Alternatively, the first network device 110 may decide to take back control of the mobility management of the terminal device. For example, the first network device 110 may transmit the instruction of de-configuration of mobility management for the terminal device to the second network device 120, if the first network device 110 determines that a distance of movement of the terminal device is within a determined threshold distance. As another example, the first network device 110 may transmit the instruction of de-configuration of mobility management for the terminal device to the second network device 120, if it determines that a further cell within coverage of a further network device can provide better quality than current serving cell in the second network device 120.

Accordingly, the second network device 120 may ceases the mobility management for the terminal device after receiving the instruction of de-configuration of mobility management for a terminal device. For example, the second network device 120 may cease the configuration of inter-cell L1 measurements to the UE and no longer transmit cell change order to the UE. Alternatively or in addition, the first network device 110 or the second network device 120 may signaled the UE to cease L1 measuring and reporting to further save power consumption.

As shown in FIG. 2, the second network device 120 transmits (210) an identification of a serving cell for the terminal device to the first network device 110. In the example embodiments where the second network device 120 transmits the request for the de-configuration of the mobility management for the terminal device to the first network device 110, the second network device 120 may contain the identification of a serving cell for the terminal device in the request for the de-configuration of the mobility management for the terminal device. Accordingly, the first network device 110 may obtain the identification of the serving cell from the request. Alternatively, for example in response to receiving the request for the de-configuration of the mobility management for the terminal device from the first network device 110, the second network device 120 may transmits the identification of a serving cell for the terminal device in a separate message. Accordingly, the first network device 110 may obtain the identification of the serving cell from the separate message.

In some example embodiments, the first network device 110 may trigger a change of the terminal device from the serving cell to the neighbor cell based on measurements for the serving cell and a neighbor cell from the terminal device. Accordingly, according to the handover instruction from the first network device 110, the terminal device may perform handover from the serving cell to the neighbor cell.

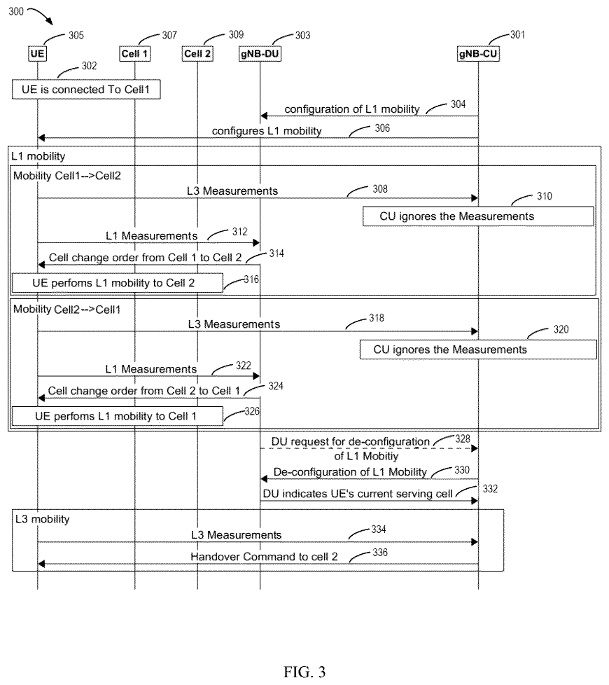

FIG. 3 shows an example process according to some example embodiments of the present disclosure. For the purpose of discussion, the process 300 will be described with reference to FIG. 1. For example, the first network device 110 as shown in FIG. 1 can be implemented by a CU 301, and the second network device 120 as shown in FIG. 1 can be implemented by a DU 303.

As shown in FIG. 3, at 302, the UE 305 is connected to the cell 1 307. Further, at 304, the CU 301 configures the DU 303 for L1 mobility of the UE 305 in Cell 1 307 and Cell 2 309. At 306, the CU 301 configures the UE 305 for L1 mobility in cell 1 307 and cell 2 309.

Then, at 308, the UE 305 reports L3 measurements for the cell 1 307 and the cell 2 309 to the CU 301, for example, because the quality of the cell 2 309 has become better than that of the cell 1 307. For the reason that the mobility of the UE 305 between the Cell 1 307 and the Cell 2 309 has been configured to be managed by the DU 303, at 310, the CU 301 ignores the L3 measurements from the UE 305, leaving the DU 303 managing the mobility of the UE 305. At 312, the UE 305 reports L1 measurements for the cell 1 307 and the cell 2 309 to the DU 303, indicating that the quality of the cell 2 309 is better than that of the cell 1 307. Then, at 314, the DU 303 instructs the UE 305 to perform cell change from the cell 1 307 to the cell 2 309. Accordingly, at 316, the UE 305 performs L1 mobility from the cell 1 307 to the cell 2 309. For example, the CU 301 is not aware of the cell change of the UE 305.

Likewise, at 318, the UE 305 reports L3 measurements to the CU 301, for example, because the quality of the cell 1 307 has become better than that of the cell 2 309. At 320, the CU 301 ignores the L3 measurements from the UE 305, leaving DU 303 managing the UE mobility. At 322, the UE 305 reports L1 measurements for the cell 1 307 and the cell 2 309 to the DU 303, indicating that the quality of the cell 1 307 is better than that of the cell 2 309. Then, at 324, the DU 303 instructs the UE 305 to perform cell change from the cell 2 309 to the cell 1 307. Accordingly, at 326, the UE 305 performs L1 mobility from the cell 2 309 to the cell 1 307. For example, the CU 301 is still not aware of the cell change of the UE 305.

At 328, the DU 303 may request to de-configure L1 mobility management for the UE 305, for example, for the reason that the DU 303 is overloaded and/or the DU 303 determines that the position of the UE 305 is not changing or changing in a slow manner. Then, at 330, the CU 301 de-configures the DU 303 for L1 mobility management of the UE 305 between the cell 1 307 and the cell 2 309. At 332, the DU 303 sends to the CU 301 the identification of the current UE's serving cell, that is, the cell 1 307 in this case. Accordingly, the DU 303 ceases the mobility management for the UE 305. Further, at 334, the UE 305 reports L3 measurements to the CU 301, indicating that the quality of the cell 2 309 is better than that of the cell 1 307. Then, at 336, the CU 301 transmits a handover command to the UE 305 to trigger a handover from the cell 1 307 to the cell 2 309.

All operations and features as described above with reference to FIGS. 1-2 are likewise applicable to the process 300 and have similar effects. For the purpose of simplification, the details will be omitted.

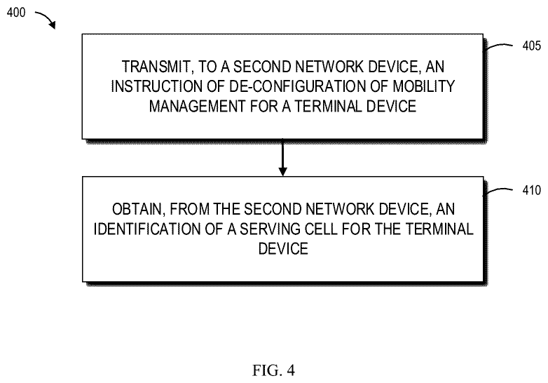

FIG. 4 shows a flowchart of an example method 400 according to some example embodiments of the present disclosure. The method 400 can be implemented at the first network device 110 as shown in FIG. 1. For the purpose of discussion, the method 400 will be described with reference to FIG. 1.

At block 405, the first network device 110 transmits, to a second network device, an instruction of de-configuration of mobility management for a terminal device. At block 410, the first network device 110 obtains, from the second network device, an identification of a serving cell for the terminal device.

In some example embodiments, the first network device 110 may trigger, based on measurements for the serving cell and a neighbor cell from the terminal device, a change of the terminal device from the serving cell to the neighbor cell.

In some example embodiments, the first network device 110 may, in response to receiving, from the second network device, a request for the de-configuration of the mobility management for the terminal device, transmit, to the second network device, the instruction of the de-configuration of the mobility management for the terminal devices.

In some example embodiments, the identification of the serving cell may be contained in the request for the de-configuration of the mobility management for the terminal device. The first network device 110 may obtain the identification of the serving cell from the request.

In some example embodiments, the first network device 110 may update, at least in part based on the plurality of received signal strength indications, a constraint model for the plurality of subnetworks. Then, the first network device 110 may in accordance with a determination that a distance of movement of the terminal device is within a determined threshold distance, transmit, to the second network device, the instruction of the de-configuration of the mobility management for the terminal device.

In some example embodiments, the first network device may be a centralized unit, and the second network device may be a distributed unit.

Those skilled in the art can understand that all operations and features as described above with reference to FIGS. 1-3 are likewise applicable to the method 400 and have similar effects.

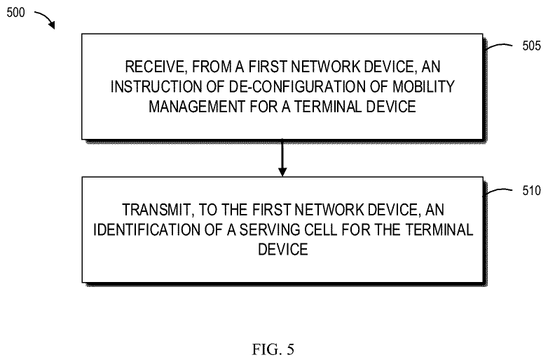

FIG. 5 shows a flowchart of an example method 500 according to some example embodiments of the present disclosure. The method 500 can be implemented at the second network device 120 as shown in FIG. 1. For the purpose of discussion, the method 400 will be described with reference to FIG. 1.

At block 505, the second network device 120 receives, from a first network device, an instruction of de-configuration of mobility management for a terminal device. At block 510, the second network device 120 transmits, to the first network device, an identification of a serving cell for the terminal device.

In some example embodiments, the second network device 120 may transmit, to the first network device, a request for the de-configuration of the mobility management for the terminal device.

In some example embodiments, the second network device 120 may, in accordance with a determination that a distance of movement of the terminal device is within a determined threshold distance, transmit, to the first network device, the request for the de-configuration of the mobility management for the terminal device.

In some example embodiments, the second network device 120 may, in response to a load of the second network device higher than a threshold load, transmit, to the first network device, the request for the de-configuration of the mobility management for the terminal device.

In some example embodiments, the identification of the serving cell is contained in the request for the de-configuration of the mobility management for the terminal device.

In some example embodiments, the second network device 120 may cease the mobility management for the terminal device.

In some example embodiments, the first network device may be a centralized unit, and the second network device may be a distributed unit.

Those skilled in the art can understand that all operations and features as described above with reference to FIGS. 1-3 are likewise applicable to the method 500 and have similar effects.

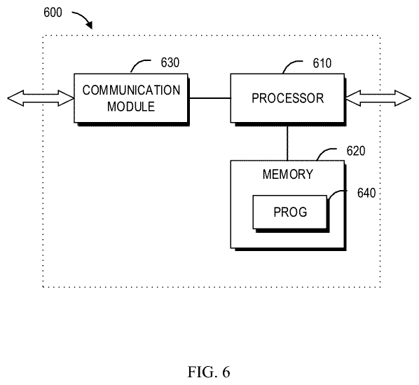

FIG. 6 is a simplified block diagram of a device 600 that is suitable for implementing example embodiments of the present disclosure. The device 600 can be implemented at or as a part of the first network device 110 or the second network device 120 as shown in FIG. 2.

As shown, the device 600 includes a processor 610, a memory 620 coupled to the processor 610, a communication module 630 coupled to the processor 610, and a communication interface (not shown) coupled to the communication module 630. The memory 620 stores at least a program 640. The communication module 630 is for bidirectional communications, for example, via multiple antennas. The communication interface may represent any interface that is necessary for communication.

The program 640 is assumed to include program instructions that, when executed by the associated processor 610, enable the device 600 to operate in accordance with the example embodiments of the present disclosure, as discussed herein with reference to FIGS. 1-5. The example embodiments herein may be implemented by computer software executable by the processor 610 of the device 600, or by hardware, or by a combination of software and hardware. The processor 610 may be configured to implement various example embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

When the device 600 acts as the first network device 110 or a part of the first network device 110, the processor 610 and the communication module 630 may cooperate to implement the method 400 as described above with reference to FIG. 1. When the device 600 acts as the second network device 120 or a part of the second network device 120, the processor 610 and the communication module 630 may cooperate to implement the method 500 as described above with reference to FIG. 1. All operations and features as described above with reference to FIGS. 1-5 are likewise applicable to the device 600 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIG. 1. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In I certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first network device, transmitting, to a second network device, an instruction of de-configuration of mobility management for a terminal device; and obtaining, from the second network device, an identification of a serving cell for the terminal device.

In some aspects, the method further comprises: triggering, based on measurements for the serving cell and a neighbor cell from the terminal device, a change of the terminal device from the serving cell to the neighbor cell.

In some example embodiments, transmitting the instruction of the de-configuration of the mobility management for the terminal device comprises: in response to receiving, from the second network device, a request for the de-configuration of the mobility management for the terminal device, transmitting, to the second network device, the instruction of the de-configuration of the mobility management for the terminal device.

In some example embodiments, the identification of the serving cell is contained in the request for the de-configuration of the mobility management for the terminal device, and obtaining the identification of the serving cell comprises: obtaining the identification of the serving cell from the request.

In some example embodiments, transmitting the instruction of the de-configuration of the mobility management for the terminal device comprises: in accordance with a determination that a distance of movement of the terminal device is within a determined threshold distance, transmitting, to the second network device, the instruction of the de-configuration of the mobility management for the terminal device.

In some example embodiments, the first network device is a centralized unit, and the second network device is a distributed unit.

In some aspects, a method comprises: at a second network device, receiving, from a first network device, an instruction of de-configuration of mobility management for a terminal device; and transmitting, to the first network device, an identification of a serving cell for the terminal device.

In some example embodiments, the method further comprising: transmitting, to the first network device, a request for the de-configuration of the mobility management for the terminal device.

In some example embodiments, transmitting the request for the de-configuration of the mobility management for the terminal device comprises: in accordance with a determination that a distance of movement of the terminal device is within a determined threshold distance, transmitting, to the first network device, the request for the de-configuration of the mobility management for the terminal device.

In some example embodiments, transmitting the request for the de-configuration of the mobility management for the terminal device comprises: in response to a load of the second network device higher than a threshold load, transmitting, to the first network device, the request for the de-configuration of the mobility management for the terminal device.

In some example embodiments, the identification of the serving cell is contained in the request for the de-configuration of the mobility management for the terminal device.

In some example embodiments, the method further comprising: ceasing the mobility management for the terminal device.

In some example embodiments, the first network device is a centralized unit, and the second network device is a distributed unit.

In some aspects, an apparatus implemented at a first network device, comprising: at least one processor; and at least one memory including computer program code; the at least one memory and the computer program code configured to, with the at least one processor, cause the apparatus to: transmit, to a second network device, an instruction of de-configuration of mobility management for a terminal device; and obtain, from the second network device, an identification of a serving cell for the terminal device.

In some example embodiments, the apparatus is further caused to trigger, based on measurements for the serving cell and a neighbor cell from the terminal device, a change of the terminal device from the serving cell to the neighbor cell.

In some example embodiments, the apparatus is caused to transmit the instruction of the de-configuration of the mobility management for the terminal device by: in response to receiving, from the second network device, a request for the de-configuration of the mobility management for the terminal device, transmitting, to the second network device, the instruction of the de-configuration of the mobility management for the terminal device.

In some example embodiments, the identification of the serving cell is contained in the request for the de-configuration of the mobility management for the terminal device, and the apparatus is caused to obtain the identification of the serving cell by: obtaining the identification of the serving cell from the request.

In some example embodiments, the apparatus is caused to transmit the instruction of the de-configuration of the mobility management for the terminal device by: in accordance with a determination that a distance of movement of the terminal device is within a determined threshold distance, transmitting, to the second network device, the instruction of the de-configuration of the mobility management for the terminal device.

In some example embodiments, the first network device is a centralized unit, and the second network device is a distributed unit.

In some aspects, an apparatus implemented at a second network device, comprising: at least one processor; and at least one memory including computer program code; the at least one memory and the computer program code configured to, with the at least one processor, cause the apparatus to receive, from a first network device, an instruction of de-configuration of mobility management for a terminal device; and transmit, to the first network device, an identification of a serving cell for the terminal device.

In some example embodiments, the apparatus is further caused to: transmit, to the first network device, a request for the de-configuration of the mobility management for the terminal device.

In some example embodiments, the apparatus is caused to transmit the request for the de-configuration of the mobility management for the terminal device by: in accordance with a determination that a distance of movement of the terminal device is within a determined threshold distance, transmitting, to the first network device, the request for the de-configuration of the mobility management for the terminal device.

In some example embodiments, the apparatus is caused to transmit the request for the de-configuration of the mobility management for the terminal device by: in response to a load of the second network device higher than a threshold load, transmitting, to the first network device, the request for the de-configuration of the mobility management for the terminal device.

In some example embodiments, the identification of the serving cell is contained in the request for the de-configuration of the mobility management for the terminal device.

In some example embodiments, the apparatus is further caused to: cease the mobility management for the terminal device.

In some example embodiments, the first network device is a centralized unit, and the second network device is a distributed unit.

In some aspects, an apparatus at a first network device comprises: means for, transmitting, to a second network device, an instruction of de-configuration of mobility management for a terminal device; and means for, obtaining, from the second network device, an identification of a serving cell for the terminal device.

In some example embodiments, the apparatus further comprises means for, triggering, based on measurements for the serving cell and a neighbor cell from the terminal device, a change of the terminal device from the serving cell to the neighbor cell.

In some example embodiments, the means for transmitting the instruction of the de-configuration of the mobility management for the terminal device comprises: means for, in response to receiving, from the second network device, a request for the de-configuration of the mobility management for the terminal device, transmitting, to the second network device, the instruction of the de-configuration of the mobility management for the terminal device.

In some example embodiments, the identification of the serving cell is contained in the request for the de-configuration of the mobility management for the terminal device, and the means for obtaining the identification of the serving cell comprises: means for obtaining the identification of the serving cell from the request.

In some example embodiments, the means for transmitting the instruction of the de-configuration of the mobility management for the terminal device comprises: means for, in accordance with a determination that a distance of movement of the terminal device is within a determined threshold distance, transmitting, to the second network device, the instruction of the de-configuration of the mobility management for the terminal device.

In some example embodiments, the first network device is a centralized unit, and the second network device is a distributed unit.

In some aspects, an apparatus at a second network device comprises: means for receiving, from a first network device, an instruction of de-configuration of mobility management for a terminal device; and means for transmitting, to the first network device, an identification of a serving cell for the terminal device.

In some example embodiments, the apparatus further comprises: means for transmitting, to the first network device, a request for the de-configuration of the mobility management for the terminal device.

In some example embodiments, the means for transmitting the request for the de-configuration of the mobility management for the terminal device comprises: means for, in accordance with a determination that a distance of movement of the terminal device is within a determined threshold distance, transmitting, to the first network device, the request for the de-configuration of the mobility management for the terminal device.

In some example embodiments, the means for transmitting the request for the de-configuration of the mobility management for the terminal device comprises: means for, in response to a load of the second network device higher than a threshold load, transmitting, to the first network device, the request for the de-configuration of the mobility management for the terminal device.

In some example embodiments, the identification of the serving cell is contained in the request for the de-configuration of the mobility management for the terminal device.

In some example embodiments, the apparatus further comprises: means for ceasing the mobility management for the terminal device.

In some example embodiments, the first network device is a centralized unit, and the second network device is a distributed unit.

In some aspects, a computer readable storage medium comprises program instructions stored thereon, the instructions, when executed by a processor of a device, causing the device to perform the method according to some example embodiments of the present disclosure.

1. An apparatus implemented at a first network device, comprising:
at least one processor; and
at least one memory storing instructions which, when executed by the at least one processor, cause the apparatus to:
transmit, to a second network device, an instruction of de-configuration of mobility management for a terminal device; and
obtain, from the second network device, an identification of a serving cell for the terminal device.

2. The apparatus of claim 1, wherein the apparatus is further caused to:
trigger, based on measurements for the serving cell and a neighbor cell from the terminal device, a change of the terminal device from the serving cell to the neighbor cell.

3. The apparatus of claim 1, wherein the apparatus is caused to transmit the instruction of the de-configuration of the mobility management for the terminal device by:
in response to receiving, from the second network device, a request for the de-configuration of the mobility management for the terminal device, transmitting, to the second network device, the instruction of the de-configuration of the mobility management for the terminal device.

4. The apparatus of claim 3, wherein the identification of the serving cell is contained in the request for the de-configuration of the mobility management for the terminal device, and the apparatus is caused to obtain the identification of the serving cell by:
obtaining the identification of the serving cell from the request.

5. The apparatus of claim 1, wherein the apparatus is caused to transmit the instruction of the de-configuration of the mobility management for the terminal device by:
in accordance with a determination that a distance of movement of the terminal device is within a determined threshold distance, transmitting, to the second network device, the instruction of the de-configuration of the mobility management for the terminal device.

6. The apparatus of claim 1, wherein the first network device is a centralized unit, and the second network device is a distributed unit.

7. An apparatus implemented at a second network device, comprising:
at least one processor; and
at least one memory storing instructions which, when executed by the at least one processor, cause the apparatus to:
receive, from a first network device, an instruction of de-configuration of mobility management for a terminal device; and
transmit, to the first network device, an identification of a serving cell for the terminal device.

8. The apparatus of claim 7, wherein the apparatus is further caused to:
transmit, to the first network device, a request for the de-configuration of the mobility management for the terminal device.

9. The apparatus of claim 8, wherein the apparatus is caused to transmit the request for the de-configuration of the mobility management for the terminal device by:
in accordance with a determination that a distance of movement of the terminal device is within a determined threshold distance, transmitting, to the first network device, the request for the de-configuration of the mobility management for the terminal device.

10. The apparatus of claim 8, wherein the apparatus is caused to transmit the request for the de-configuration of the mobility management for the terminal device by:
in response to a load of the second network device higher than a threshold load, transmitting, to the first network device, the request for the de-configuration of the mobility management for the terminal device.

11. The apparatus of claim 7, wherein the identification of the serving cell is contained in the request for the de-configuration of the mobility management for the terminal device.

12. The apparatus of claim 7, wherein the apparatus is further caused to:
cease the mobility management for the terminal device.

13. The apparatus of claim 7, wherein the first network device is a centralized unit, and the second network device is a distributed unit.

14. A method comprising:
at a first network device:
transmitting, to a second network device, an instruction of de-configuration of mobility management for a terminal device; and
obtaining, from the second network device, an identification of a serving cell for the terminal device.

15. The method of claim 14, further comprising:
triggering, based on measurements for the serving cell and a neighbor cell from the terminal device, a change of the terminal device from the serving cell to the neighbor cell.

16. The method of claim 14, wherein transmitting the instruction of the de-configuration of the mobility management for the terminal device comprises:
in response to receiving, from the second network device, a request for the de-configuration of the mobility management for the terminal device, transmitting, to the second network device, the instruction of the de-configuration of the mobility management for the terminal device.

17. The method of claim 16, wherein the identification of the serving cell is contained in the request for the de-configuration of the mobility management for the terminal device, and obtaining the identification of the serving cell comprises:
obtaining the identification of the serving cell from the request.

18. The method of claim 14, wherein transmitting the instruction of the de-configuration of the mobility management for the terminal device comprises:
in accordance with a determination that a distance of movement of the terminal device is within a determined threshold distance, transmitting, to the second network device, the instruction of the de-configuration of the mobility management for the terminal device.

19. The method of claim 14, wherein the first network device is a centralized unit, and the second network device is a distributed unit.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A computer readable storage medium comprising program instructions stored thereon, the instructions, when executed by a processor of a device, causing the device to perform a method of:
at a first network device:
transmitting, to a second network device, an instruction of de-configuration of mobility management for a terminal device; and
obtaining, from the second network device, an identification of a serving cell for the terminal device.
